(19) United States
(12) Patent Application Publication
(10) Pub. No.: US 2014/0116255 A1
(43) Pub. Date: May 1, 2014

(54) AXIAL GAS-LIQUID CYCLONE SEPARATOR

(71) Applicant: Intevep, S.A., Caracas (VE)

(72) Inventors: Luis Daniel Pérez Guerra, Estado Miranda (VE); Jorge Nicolas Trujillo Mercado, Perth (AU); William Alejandro Blanco Berra, Los Teques (VE)

(73) Assignee: Intevep, S.A., Caracas (VE)

(21) Appl. No.: 14/064,288

(22) Filed: Oct. 28, 2013

Related U.S. Application Data
(60) Provisional application No. 61/720,577, filed on Oct. 31, 2012.

(51) Int. Cl. B01D 19/00

(52) U.S. Cl. CPC B01D 19/0057
USPC 96/216

(57) ABSTRACT

An axial gas-liquid cyclone separator, comprising a housing having a wet gas inlet and a dry gas outlet aligned along an axis of the housing; an internal wall section in the housing and defining, within the housing, a pre-separation chamber and a main liquid separation chamber; an assembly comprising a static mixer and a swirl generator mounted in a tube and extended through the internal wall section; liquid outlets in at least the main chamber for outlet of liquids separated from the wet gas; and a vortex finder mounted between the tube and the dry gas outlet.

### CROSS REFERENCE TO RELATED APPLICATION

This application claims the benefit of provisional application Ser. No. 61/720,517, filed Oct. 31, 2012.

### BACKGROUND OF THE INVENTION

The invention relates to separation of gas and liquid and, more particularly, to a cyclone separator for gas-liquid separation.

The oil and gas industry faces challenges such as new offshore fields located in harsher environments, at greater distances from shore, in deeper waters, demanding more compact, efficient process facilities, to optimize investment costs and guarantee the economic feasibility of these new projects.

Separation of gas from liquid is an important aspect of these challenges. Brown fields with decaying production experience significant changing process conditions which usually impose constraints in existing facilities. Debottlenecking of these facilities requires process improvements to increase capacity and efficiency, at the same time minimizing any production deferment which could translate into unwanted higher operational costs. Usually there are severe space limitations for solutions to be deployed, demanding such solutions to become more and more compact. The need exists for a compact, high efficiency and high capacity separation technology to address potential gas scrubbing problems in both green and brown fields, and the present invention is an answer to these needs.

### SUMMARY OF THE INVENTION

According to the invention, an axial gas-liquid cyclone separator has been provided which comprises a housing having a wet gas inlet and a dry gas outlet aligned along an axis of the housing; an internal wall section in the housing and defining, within the housing, a pre-separation chamber and a main liquid separation chamber; an assembly comprising a static mixer and a swirl generator mounted in a tube and extended through the internal wall section; liquid outlets in at least the main chamber for outlet of liquids separated from the wet gas; and a vortex finder mounted between the tube and the dry gas outlet.

The assembly of static mixer and swirl generator is preferably arranged so that the static mixer is positioned to receive flow of wet gas in the pre-separation chamber, and the swirl generator is downstream of the static mixer to induce a swirling flow of the mixed wet gas as desired. The tube in which the static mixer and swirl generator are mounted can advantageously be mounted coaxially with the wet gas inlet and dry gas outlet.

The separator has a flow conditioning or pre-separation section or chamber, a swirl generator section and a segregating or main liquid separation section or chamber with a discharge for gas and liquid phases.

Additional features and advantages of this device are disclosed herein.

The disclosed axial cyclone separator meets the needs identified above.

### BRIEF DESCRIPTION OF THE DRAWING

A detailed description of preferred embodiments of the present invention follows, with reference to the attached drawings, wherein:

FIG. 1 is a cross sectional view of an axial gas-liquid cyclone separator in accordance with the present invention.

FIG. 2 is a separate illustration of a static mixing element for use in an apparatus according to the invention.

FIG. 3 is an illustration of a swirl generator in accordance with the present invention;

FIG. 4 shows a flow conditioning apparatus suitable for use in a separator according to the invention; and

FIG. 5 is a further cross sectional view of the separator according to the invention showing wet gas, liquid and dry gas flow there through.

### DETAILED DESCRIPTION

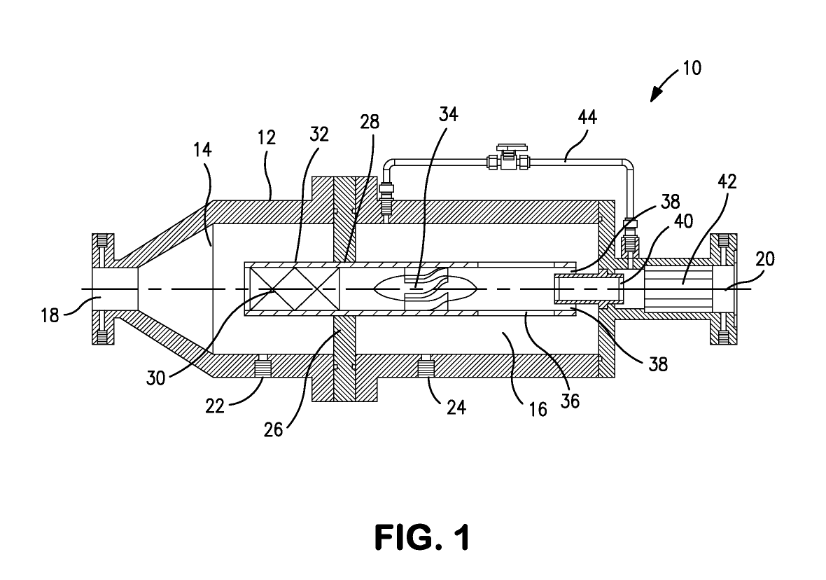

FIG. 1 illustrates a cyclone separator 10 in accordance with the present invention. Cyclone separator 10 includes a housing 12 which defines a pre-separation chamber 14 and a main liquid separation chamber 16. A wet gas inlet 18 is defined on cyclone separator 10 for introduction of a gas with entrained liquid which is to be separated. A dry gas outlet 20 is defined, preferably at the opposite end of cyclone separator 10 as shown in the drawings, for discharge of a dried gas as desired. One or more drains or outlets for liquid can also be defined on housing 12 of cyclone separator 10 in accordance with the invention. In the embodiment illustrated, two liquid outlets 22, 24 are shown.

As shown, separator 10 is an axial separator wherein flow passes through the separator as shown in FIG. 5, from left to right and along the axis of the device. The pre-separation chamber 14 advantageously has a conical wall section expanding the flow area from wet gas inlet 18, and having liquid outlet 22 defined in a wall of housing 12 as shown such that liquid separated in pre-separation chamber 14 drains from cyclone separator 10 as desired. An internal wall section 26 separates pre-separation chamber 14 from main liquid separation chamber 16, and has a central opening 28 at which is mounted a static mixer 30 as shown. Static mixer 30 leads to a tube 32 which passes through central opening 28, and which next leads to a swirl generator 34 which advantageously may have a rounded conical shape facing upstream toward incoming gas flow, and may also have a rounded conical shape facing downstream away from the incoming gas flow, and which has a series of fins which are positioned to generate a swirl of the incoming gas flow. At this portion of the device, tube 32 has longitudinal slits 36 and axial liquid drainage areas 38 through which separated liquid can pass. Swirling gas flowing through tube 32 reaches vortex finder 40 from or the outlet tube of tube 32, and passes through flow gas conditioner 42 to dry gas outlet 20. A recycle gas pipe 44 can be provided and flows from the vicinity of vortex finder 40 back to an upstream area of the main liquid separation chamber 16.

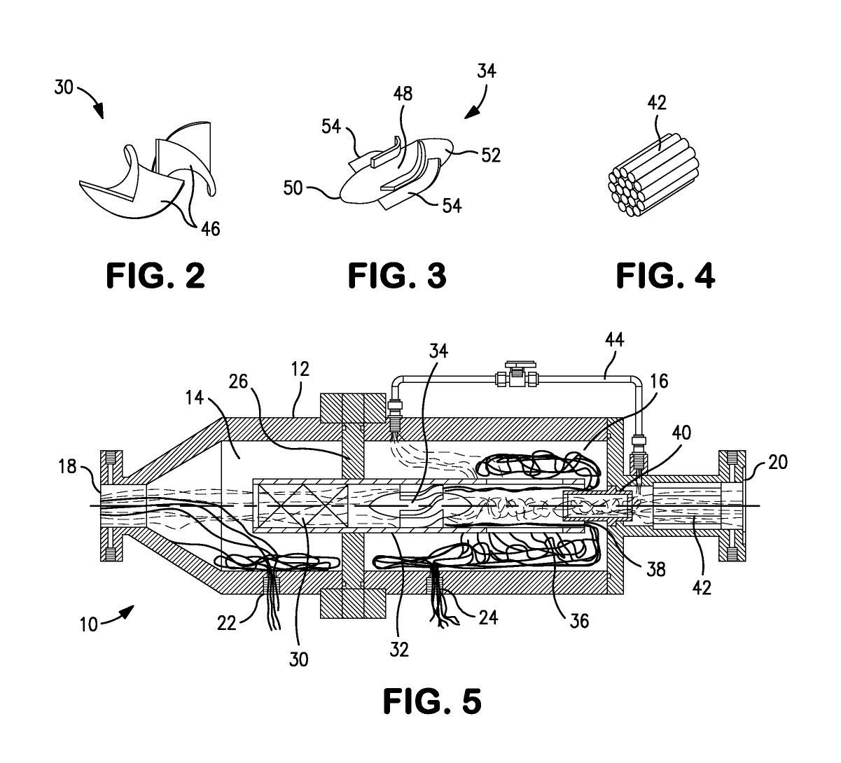

Referring to FIG. 2, elements from static mixer 30 are illustrated in the form of several curved elements 46 which are positioned along the interior of tube 32 to thoroughly mix gas and entrained liquid which enters tube 32. In accordance with the invention, it has been found that obtaining a good mix of these elements prior to the swirl generator helps to produce a more complete separation of phases as desired. In the meantime, it should be appreciated that the curved elements 46 illustrated in FIG. 2 are only one acceptable embodiment of any number of shapes of structures for a static mixer to be used in accordance with he present invention, and that many other shapes of elements of a static mixer could be used, as would be known to a person having ordinary skill in the art, within the broad scope of the present invention.

FIG. 3 further illustrates the configuration of swirl generator 34 in accordance with the present invention. As shown, swirl generator 34 can have a substantially cylindrical central body portion 48 with rounded conical portions 50, 52 facing up and downstream. The elongate or central body portion 48 has curved flow vanes 54 extending radially outwardly from portion 48. These vanes begin substantially parallel to the axis of body portion 48, and then curve partially around the circumference of body portion 48 as shown in FIG. 3. These vanes preferably curve in a substantially parallel or uniform manner, such that flow of gas encountering these vanes will be substantially uniformly guided into a swirling flow.

As shown, swirl generator 34 is preferably positioned within tube 32 such that vanes 54 contact the inner wall of tube 32 such that gas flowing through tube 32 completely encounters vanes 54 for inducing of a swirl flow as desired.

Tube 32 in accordance with the present invention preferably extends upstream from internal wall section 26 to receive an initial flow of wet gas, and extends downstream from wall 26 toward dry gas outlet 20. The swirling flow generated within tube 32 and downstream of swirl generator 34 is such that liquid is separated against the inner wall of tube 32. To help in separation of this liquid once separated, longitudinal slits 36 extend along tube 32 downstream of swirl generator 34 and are positioned to allow separated liquid to drop, by gravity, into the portion of main liquid chamber 16 outside of tube 32.

As shown in FIGS. 1 and 5, vortex finder 40 is positioned in dry gas outlet 20 and axially aligned with tube 32 such that dry gas flowing along the central portion of tube 32 enters vortex finder 40 and at this point, the flow of gas is substantially dry. As shown, an annular gap or space is defined between vortex finder 40 and an open downstream end of tube 32 to define axially liquid drainage areas 38 where additional liquid, separated from the dried gas, can flow into the portion of chamber 16 outside of tube 32 and eventually exit from liquid outlet 24.

FIG. 4 shows a preferred embodiment of flow gas conditioner 42 and may be a series of parallel tubes or other flow area having straight internal structures to define a plurality of substantially parallel flow passages. Flow conditioner 42 advantageously serves to straighten the flow of gas through dry gas outlet 20 before this gas passes to further gas transportation facilities such as a gas pipeline or conduit or the like. Of course, such dry gas may be passed to other treatment facilities for other types of scrubbing or the like, or transported to any other end use which would be known to a person of ordinary skill in the art.

Recycled gas pipe 44 is advantageously connected from dry gas outlet 20 back to an upstream location of chamber 16, for example an inlet through a wall of housing 12 such that any over pressure of gas from outlet 20 can be recycled back through chamber 16 for another pass through chamber 16 prior to again flowing to dry gas outlet 20.

FIG. 5 shows the flow path of gas and liquid through separator 10 according to the invention, with gas flow being illustrated in dashed lines and liquid flow being illustrated in solid lines. As shown, the phases enter wet gas inlet 18 together, where some of the mixture enters static mixer 30 while some of the liquid drops to the bottom of pre-separation chamber 14 due to the flow expansion of the conically expanding inner wall of chamber 14. This separated liquid exits from liquid outlet 22.

The flow arrows also illustrate swirling flow generated by swirl generator 34, with swirling gas flow passing substantially centrally along the axis of tube 32 and liquid moving radially outwardly from the gas. This serves to separate the liquid which flows through longitudinal slots in tube 32 and exists from liquid outlet 24 while the drive gas passes through vortex finder 40 to flow gas conditioner 42 and out of dry gas outlet 20.

It should be readily appreciated that the structure of the separator in accordance with the present invention advantageously serves to provide a highly effective and efficient separation of liquid from gas, and that the structure provides this separation in a very compact and space-saving device.

It should readily be appreciated that a wet gas fed to wet gas inlet 18 of cyclone separator 10 in accordance with present invention first encounters pre-separation chamber 14 where an initial separated liquid can be generated, and where the remaining wet gas flow is subjected to static mixer 30 and swirl generator 34 to generate dry gas as desired.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

1. An axial gas-liquid cyclone separator, comprising:
a housing having a wet gas inlet and a dry gas outlet aligned along an axis of the housing;
an internal wall section in the housing and defining, within the housing, a pre-separation chamber and a main liquid separation chamber;
an assembly comprising a static mixer and a swirl generator mounted in a tube and extended through the internal wall section;
liquid outlets in at least the main chamber for outlet of liquids separated from the wet gas; and
a vortex finder mounted between the tube and the dry gas outlet.

2. The apparatus of claim 1, wherein the tube has longitudinal drainage slits for passage of liquid from within the tube to the main chamber.

3. The apparatus of claim 2, wherein the longitudinal drainage slits extend along a portion of the tube that is downstream from the swirl generator and inside the main chamber.

4. The apparatus of claim 1, wherein the tube is substantially coaxial with the wet gas inlet and the dry gas outlet.

5. The apparatus of claim 1, wherein the static mixer is upstream of the swirl generator in the tube.

6. The apparatus of claim 1, wherein the static mixer comprises at least one mixing vane at a gas inlet end of the tube for mixing gas and liquid entering the tube.

7. The apparatus of claim 1, wherein the swirl generator comprises an elongate body in the tube and having curved flow vanes extending radially outwardly from the elongate body, the curved flow vanes having an upstream portion which is substantially parallel to an axis of the tube, and a downstream portion which is angled relative to the axis of the tube.

8. The apparatus of claim 7, wherein the elongate body has a rounded conical upstream facing end.

9. The apparatus of claim 7, wherein the elongate body has a rounded conical downstream facing end.

10. The apparatus of claim 7, wherein the elongate body has a rounded conical upstream facing end and a rounded conical downstream facing end.

11. The apparatus of claim 1, wherein the vortex finder is a tube mounted in the housing and extending upstream from the dry gas outlet to a downstream end of the tube, the vortex finder being substantially coaxial with the swirl generator.

12. The apparatus of claim 1, further comprising a gas flow conditioner positioned between the vortex finder and the dry gas outlet.

13. The apparatus of claim 12, wherein the gas flow conditioner comprises a plurality of substantially parallel straight flow pipes extending from the vortex finder to the dry gas outlet.

14. The apparatus of claim 1, further comprising a recycle gas pipe communicated from the dry gas outlet to the main liquid separation chamber.

15. The apparatus of claim 1, wherein the static mixer extends from the internal wall section against the direction of flow into the pre-separation chamber, and wherein the swirl generator is within the tube in the proximity of the internal wall section, within the main liquid separation chamber.
